(19) United States
(12) Patent Application Publication
(10) Pub. No.: US 2026/0341938 A1
(43) Pub. Date: Oct. 29, 2026

(54) SECONDARY BATTERY

(71) Applicant: Prime Planet Energy & Solutions, Inc., Tokyo (JP)

(72) Inventors: Naofumi NAKATA, Nara-shi (JP); Shigeru MATSUMOTO, Toyohashi-shi (JP); Naoya TADA, Himeji-shi (JP)

(21) Appl. No.: 19/656,890

(22) Filed: Apr. 23, 2026

(30) Foreign Application Priority Data
Apr. 28, 2025 (JP) 2025-074718

(51) Int. Cl. H01M 50/655; H01M 50/103; H01M 50/15; H01M 50/186; H01M 50/198

(52) U.S. Cl. CPC H01M 50/655; H01M 50/103; H01M 50/15; H01M 50/186; H01M 50/198

(57) ABSTRACT

In the present secondary battery, a protrusion having an annular shape is provided in a sealing plate at a region outside a first electrolyte solution injection port in a radial direction, a sealing member includes an elastically deformable elastic region on a surface of the sealing member in contact with the sealing plate at a region including the protrusion, and by applying pressing force to the elastic region from the first electrolyte solution injection port side so as to compress the elastic region, the sealing member maintains an open state in which a clearance between the sealing member and the sealing plate is formed, and maintains sealing of the first electrolyte solution injection port only by the elastic force of the elastic region with the pressing force being released to release compression of the elastic region by the pressing force.

### CROSS REFERENCE TO RELATED APPLICATIONS

This nonprovisional application is based on Japanese Patent Application No. 2025-074718 filed on Apr. 28, 2025 with the Japan Patent Office, the entire contents of which are hereby incorporated by reference.

### BACKGROUND OF THE INVENTION

### Field of the Invention

The present technology relates to a secondary battery.

### Description of the Background Art

Regarding a structure of a secondary battery, a technology of providing an electrolyte solution injection port for injecting an electrolyte solution into an exterior container of the secondary battery is disclosed in, for example, each of Chinese Utility Model No. 221176555, Japanese Patent Laying-Open No. H 09-288999, Japanese Patent Laying-Open No. 2001-110388, Japanese Patent Laying-Open No. 2014-170648, and U.S. Patent Publication No. 2024/0128609.

### SUMMARY OF THE INVENTION

In the configuration of the conventional secondary battery, it has been known that an internal pressure in the exterior container of the secondary battery is increased at the terminal stage of the life of the secondary battery.

In view of the structure of the secondary battery, an internal structure such as the electrode assembly or the electrolyte solution needs to be sealed and isolated from the outside of the secondary battery and the exterior container of the secondary battery cannot be opened again once sealed, with the result that the pressure cannot be decreased even when the internal pressure in the exterior container is increased at the terminal stage of the battery life.

An object of the present disclosure is to provide a secondary battery having a configuration by which an internal pressure in an exterior container can be readily reduced at any timing.

The present technology provides the following secondary battery.
[1] A secondary battery comprising: an electrode assembly; an exterior container provided with an opening; and a sealing plate that seals the opening with the electrode assembly being accommodated inside the exterior container, wherein the sealing plate is provided with a first electrolyte solution injection port for injecting an electrolyte solution into the exterior container, the sealing plate has a sealing member, the sealing member is supported on a side of the sealing plate inside the exterior container by a support member provided to cover the first electrolyte solution injection port from inside the exterior container, a protrusion is provided in one of the sealing plate and the sealing member at a region outside the first electrolyte solution injection port in a radial direction, the protrusion having an annular shape and protruding toward the other, the sealing member includes an elastic region on a surface of the sealing member in contact with the sealing plate at a region including the protrusion, the elastic region being elastically deformable, and by applying pressing force to the elastic region from a side of the first electrolyte solution injection port so as to compress the elastic region, the sealing member maintains an open state in which a clearance between the sealing member and the sealing plate is formed, and maintains sealing of the first electrolyte solution injection port only by elastic force of the elastic region with the pressing force being released to release compression of the elastic region by the pressing force.
[2]

The secondary battery according to [1], wherein the protrusion is provided on the sealing plate.
[3]

The secondary battery according to [2], wherein the protrusion is composed of the same material as a material of the sealing plate.

[4] The secondary battery according to any one of [1] to [3], wherein the sealing member is constituted of a single elastic material.

[4] The secondary battery according to any one of [1] to [3], wherein the sealing member includes a first region constituting the elastic region, and a second region having a hardness larger than a hardness of the first region, and in the second region, a region facing the first electrolyte solution injection port is exposed.
[6] The secondary battery according to any one of [1] to [5], wherein the support member is provided with a second electrolyte solution injection port communicating with an inner side of the exterior container.
[7] The secondary battery according to any one of [1] to [6], wherein the support member is composed of the same material as a material of the sealing plate.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view of a prismatic secondary battery according to a first embodiment.

FIG. 2 is a partial longitudinal cross sectional view showing a configuration (sealing state) of a first electrolyte solution injection port according to the first embodiment.

FIG. 3 is a plan view showing an arrangement of a protrusion provided around the first electrolyte solution injection port according to the first embodiment as viewed from an inner side of the sealing plate.

FIG. 4 is a partial longitudinal cross sectional view showing a configuration (open state) of the first electrolyte solution injection port according to the first embodiment.

FIG. 5 is a longitudinal cross sectional view showing another implementation of the sealing member according to the first embodiment.

FIG. 6 is a longitudinal cross sectional view showing another implementation of the sealing member according to the first embodiment.

FIG. 7 is a longitudinal cross sectional view showing another implementation of the sealing member of the first embodiment.

FIG. 8 is a longitudinal cross sectional view showing another implementation of the sealing member according to the first embodiment.

FIG. 9 is a longitudinal cross sectional view showing another implementation of the sealing member according to the first embodiment.

FIG. 10 is a longitudinal cross sectional view showing another implementation of the sealing member according to the first embodiment.

FIG. 11 is a partial longitudinal cross sectional view showing a configuration (sealing state) of a first electrolyte solution injection port according to a second embodiment.

FIG. 12 is a cross sectional view along a line XII-XII in FIG. 11.

FIG. 13 is a longitudinal cross sectional view showing assembling of the sealing member according to the second embodiment.

FIG. 14 is a partial cross sectional view showing a configuration (open state) of the first electrolyte solution injection port according to the second embodiment.

FIG. 15 is a longitudinal cross sectional view showing another implementation of the sealing member according to the second embodiment.

FIG. 16 is a transverse sectional view showing another implementation of the sealing member according to the second embodiment.

FIG. 17 is a longitudinal cross sectional view showing another implementation of the sealing member according to the second embodiment.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

In the embodiments described below, when reference is made to number, amount, and the like, the scope of the present technology is not necessarily limited to the number, amount, and the like unless otherwise stated particularly. In the embodiments described below, each component is not necessarily essential to the present technology unless otherwise stated particularly.

In the present specification, the terms “comprise”, “include”, and “have” are open-end terms. That is, when a certain configuration is included, a configuration other than the foregoing configuration may or may not be included. The present technology is not limited to one that necessarily exhibits all the functions and effects stated in the present embodiment.

In the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

In the present specification, the term “secondary battery” is not limited to a lithium ion battery, and may include other secondary batteries such as a nickel-metal hydride battery and a sodium-ion battery. In the present specification, the term “electrode” may collectively represent a positive electrode and a negative electrode.

In the figures, regarding a shape of a prismatic exterior of a secondary battery, a width direction (leftward/rightward direction in the figure) is defined as an X direction, a height direction (upward/downward direction in the figure) is defined as a Z direction, and the X direction, the Y direction, and the Z direction are orthogonal to one another. In order to facilitate understanding of the invention, the size of each configuration in the figures may be illustrated to be changed from its actual size.

### First Embodiment: Secondary Battery 1

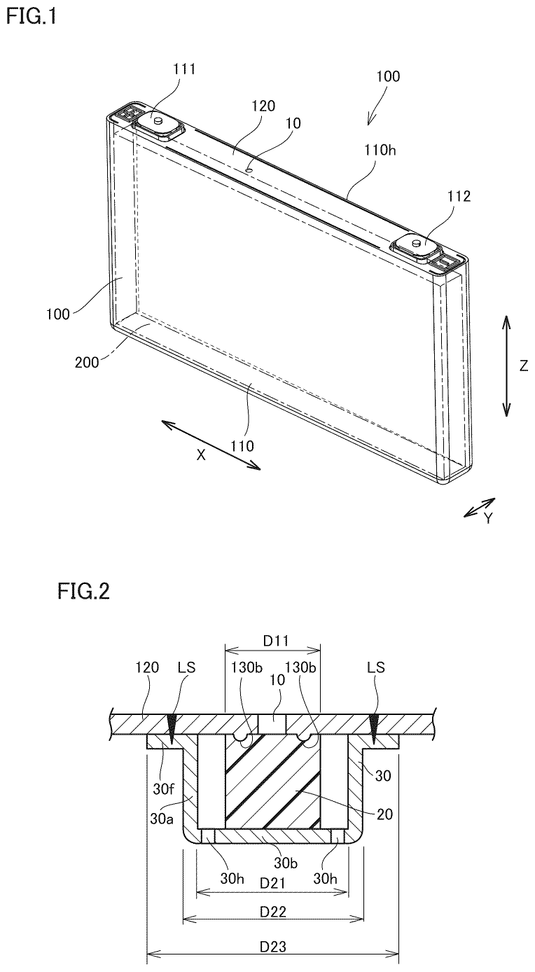

Referring to FIG. 1, as an exemplary secondary battery, a configuration of a prismatic secondary battery will be described in the present embodiment. A secondary battery 1 includes a battery case 100, an electrode assembly 200, a first electrode 111 (positive electrode terminal), and a second electrode 112 (negative electrode terminal).

Battery case 100 includes: a prismatic exterior container 110 serving as an exterior container, having a prismatic tubular shape with a bottom, and provided with an opening 110h; and a sealing plate 120 that seals opening 110h of exterior container 110. Each of exterior container 110 and sealing plate 120 is preferably composed of a metal, and is preferably composed of aluminum or an aluminum alloy. The outer sizes of exterior container 110 having the prismatic shape may be 30 mm or more in width, 300 mm or more in length, and 0.65 mm or less in plate thickness. The outer sizes of sealing plate 120 may be 30 mm or more in width, 300 mm or more in length, and 2 mm or less in thickness.

Sealing plate 120 is provided with a first electrolyte solution injection port 10. An electrolyte solution is injected into battery case 100 from first electrolyte solution injection port 10. In secondary battery 1 of the present embodiment, a sealing member 20 that seals first electrolyte solution injection port 10 is provided at first electrolyte solution injection port 10.

Referring to FIGS. 2 to 4, on a side of sealing plate 120 inside exterior container 110, sealing member 20 is accommodated in a support member 30 provided to cover first electrolyte solution injection port 10 from inside exterior container 110. Support member 30 includes a cylindrical portion 30a, a bottom portion 30b, and a flange portion 30f. Flange portion 30f is fixed to sealing plate 120 using laser LS or the like. A plurality of second electrolyte solution injection ports 30h communicating with the inside of exterior container 110 are provided in bottom portion 30b of support member 30. Support member 30 may be composed of the same material as the material of sealing plate 120. It should be noted that the material is not limited to the same material as that of sealing plate 120 as long as the material has resistance against the electrolyte solution.

The opening diameter of first electrolyte solution injection port 10 depends on the capacity of secondary battery 1, and is larger as an amount of injection per unit time is larger, but is preferably 1.0 mm or more.

The inner diameter (D21) of cylindrical portion 30a of support member 30 is preferably equal to or larger than the outer diameter of sealing member 20 (D11)+0.5 mm. The outer diameter (D22) of cylindrical portion 30a is preferably equal to or larger than the inner diameter (D21) of cylindrical portion 30a+0.2 mm. The outer diameter (D23) of flange portion 30f of support member 30 is preferably as large as the outer diameter (D22) of cylindrical portion 30a+2 mm. It should be noted that the width of flange portion 30f is preferably 1.0 mm or less.

The inner diameters of second electrolyte solution injection ports 30h provided in bottom portion 30b are preferably such that: the total opening area of second electrolyte solution injection ports 30h is larger than the opening area of first electrolyte solution injection port 10 and the number of second electrolyte solution injection ports 30h is preferably one or more. Each of second electrolyte solution injection ports 30h is preferably provided in bottom portion 30b at a region not covered with sealing member 20. Second electrolyte solution injection port 30h may be provided in cylindrical portion 30a. The shape of second electrolyte solution injection port 30h may be any shape.

In the present embodiment, sealing member 20 is constituted of a single elastic material that can be elastically deformed. Sealing member 20 preferably has a chemical resistance, and an elastomer resin or another elastic member is used therefor. Sealing member 20 has a cylindrical shape. The outer diameter of sealing member 20 is preferably equal to or more than 3.0 mm or more and equal to less than [the thickness of secondary battery 1 (Y direction)−(the plate thickness of exterior container 110×2)] mm or less. The height of sealing member 20 is preferably 1.0 mm or more and 20.0 mm.

A protrusion 130b having an annular shape and protruding toward sealing member 20 is provided in sealing plate 120 at a region outside first electrolyte solution injection port 10 in the radial direction. Protrusion 130b is provided at a region including a surface (elastic region) of sealing member 20 facing sealing plate 120. In the present embodiment, protrusion 130b is formed in one piece with sealing plate 120 using the same material as that of sealing plate 120.

In the present embodiment, protrusion 130b is composed of the same material as (formed in one piece with) sealing plate 120, but may have a structure different from that of sealing plate 120 or may be composed of a material different from that of sealing plate 120 (for example, the same material as sealing member 20). It is preferable to use a combination of materials that are not adhered or bonded to sealing member 20 while being in close contact with sealing plate 120 to secure a sealing property.

The shape (cross sectional shape) of protrusion 130b is semicircular in the present embodiment, but is not limited to this cross sectional shape, and various shapes can be employed. A shape adjusted in area of contact with sealing member 20 is conceivable, and from the viewpoint of putting importance on the area (sealing area) of the seal, the area of the seal is larger in the following order: triangle (small)<semicircular<trapezoid or square (large). On the other hand, from the viewpoint of putting importance on the surface pressure of the seal (sealing surface pressure), the surface pressure of the seal is smaller in the following order: triangle (large)>semicircle>trapezoid or square (small). For the shape (cross sectional shape) of protrusion 130b, a suitable cross sectional shape is appropriately selected in accordance with the capacity of secondary battery 1.

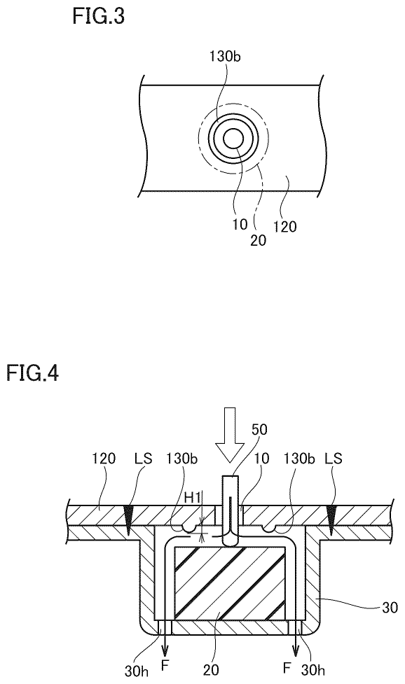

Referring to FIG. 3, the outer diameter (D31) mm of protrusion 130b may satisfy [the outer diameter (D31)>the inner diameter (D32)≥the diameter of first electrolyte solution injection port 10] mm. The inner diameter (D32) mm of protrusion 130b may satisfy [the inner diameter (D32)<the outer diameter (D31)≤the diameter of the upper surface of sealing member 20] mm. The protrusion height (H1) of protrusion 130b may satisfy 0.05 (mm)≤H1≤1.0 mm. An alternate long and short dashed line in FIG. 3 shows the arrangement position of sealing member 20 for the sake of convenience.

Referring to FIG. 4, by applying pressing force to sealing member 20 from the first electrolyte solution injection port 10 side using a jig 50 or the like so as to compress sealing member 20, sealing member 20 maintains an open state in which a clearance between sealing member 20 and sealing plate 120 is formed. As a result, the electrolyte solution can be injected into exterior container 110 through first electrolyte solution injection port 10 and second electrolyte solution injection ports 30h (arrows F in the figure). Further, internal pressure in exterior container 110 can be readily reduced at any timing.

On the other hand, the sealing of first electrolyte solution injection port 10 is maintained only by the elastic force of sealing member 20 with the pressing force being released to release the compression by the pressing force on sealing member 20 (state shown in FIG. 2). Therefore, when accommodating sealing member 20 into support member 30, sealing member 20 is preferably accommodated with sealing member 20 being elastically deformed to some extent.

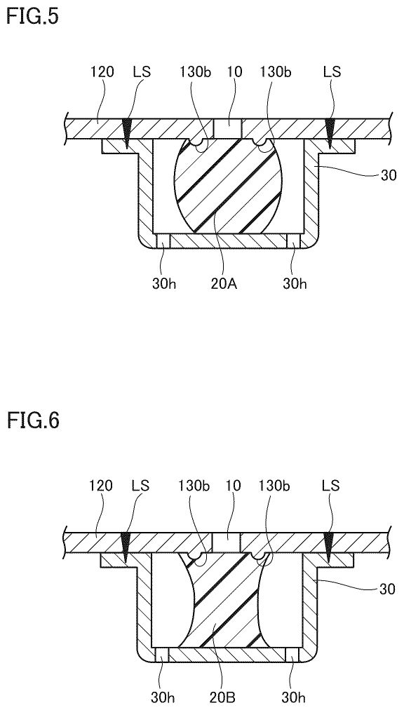

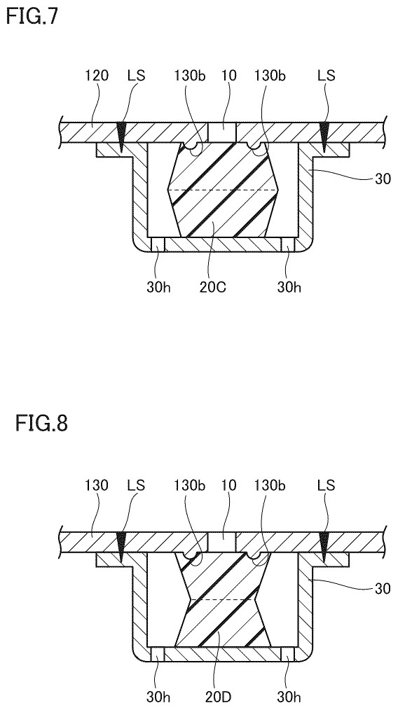

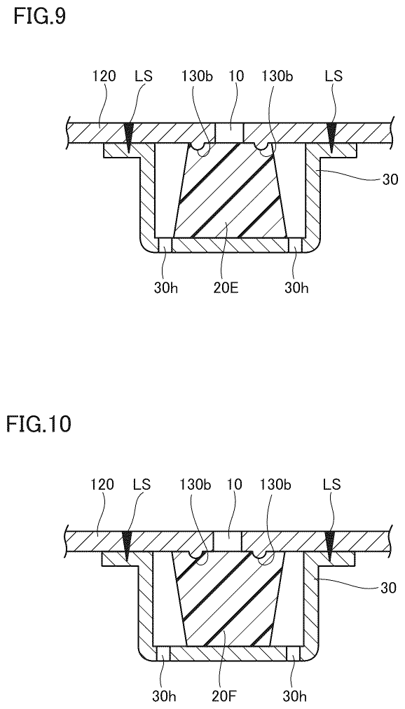

Referring to FIGS. 5 to 10, the shape of sealing member 20 is not limited to the above-described cylindrical shape, and may be any of the following shapes: a sealing member 20A having a barrel shape (see FIG. 5); a sealing member 20B (see FIG. 6) having a shape constricted at its center; a sealing member 20C (see FIG. 7) having a shape in which the sides of the large base sides of truncated cones face each other; a sealing member 20D (see FIG. 8) having a shape in which the sides of the small base sides of truncated cones face each other; a sealing member 20E (see FIG. 9) having a truncated cone shape (the side of the small base side thereof faces first electrolyte solution injection port 10); and a sealing member 20F (see FIG. 10) having a truncated cone shape (the side of the large bottom side thereof faces first electrolyte solution injection port 10).

With each of sealing member 20A having the barrel shape, sealing member 20C (see FIG. 7) having the shape in which the large bottom sides of the truncated cone face each other, and sealing member 20E (see FIG. 9) having the truncated cone shape (the small bottom side thereof faces first electrolyte solution injection port 10), it is possible to secure a large surface pressure on protrusion 130b and attain small pressing force on the sealing member at the time of the injection of the electrolyte solution.

On the other hand, with each of sealing member 20B (see FIG. 6) having the shape constricted at its center, sealing member 20D (see FIG. 8) having the shape in which the sides of the small base sides of the truncated cones face each other, and sealing member 20F (see FIG. 10) having the truncated cone shape (the side of the large base thereof faces first electrolyte solution injection port 10), it is possible to secure a large sealing area (seal area) while attaining small pressing force on the sealing member at the time of the injection of the electrolyte solution.

As described above, in secondary battery 1 according to the present embodiment, sealing member 20 is provided to enable selection between the state in which first electrolyte solution injection port 10 is maintained to be sealed and the state in which first electrolyte solution injection port 10 is maintained to be opened.

Thus, when injecting the electrolyte solution into first electrolyte solution injection port 10, by elastically deforming sealing member 20, the electrolyte solution can be readily injected into exterior container 110 through first electrolyte solution injection port 10 and second electrolyte solution injection port 30h. Further, since the inside of exterior container 110 of secondary battery 1 can be accessed at any timing until the terminal stage of the life of secondary battery 1, it is possible to readily replenish the electrolyte solution and reduce the internal pressure by releasing gas from the inside of exterior container 110.

### Second Embodiment

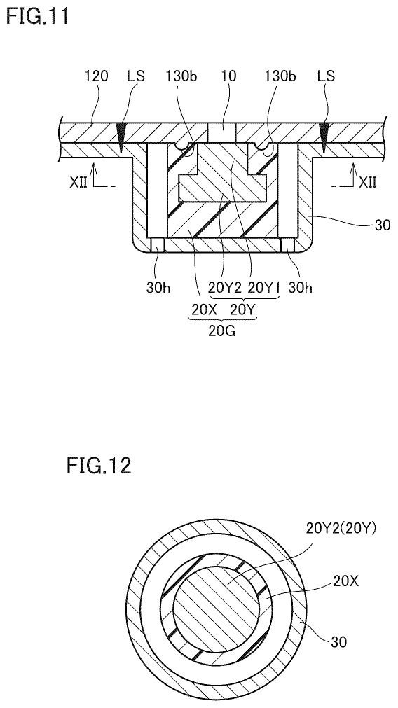

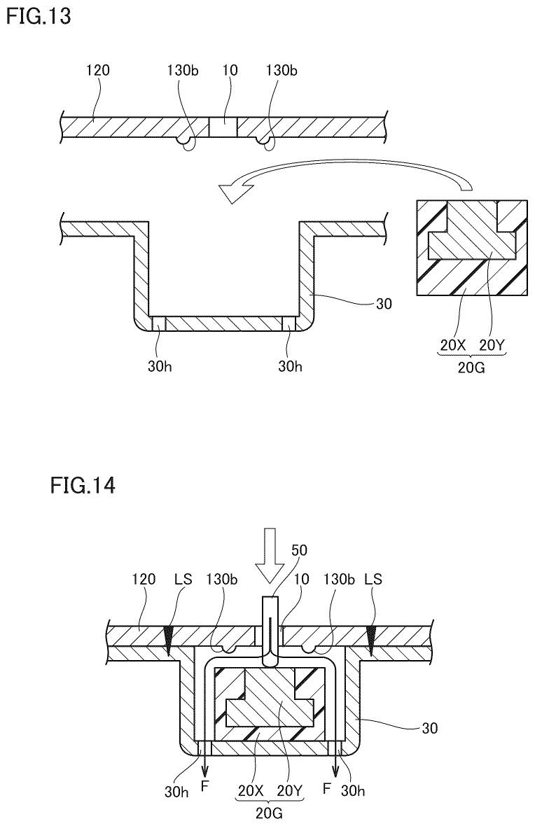

The configuration of a secondary battery according to a second embodiment will be described with reference to FIGS. 11 to 14. The basic configuration of the secondary battery according to the second embodiment is the same as that of secondary battery 1 according to the first embodiment. A difference lies in that the configuration of a sealing member 20G is different. Therefore, the configuration of sealing member 20G will be described below.

Referring to FIGS. 11 to 13, the sealing member according to the first embodiment is constituted of the single elastic material that can be elastically deformed. On the other hand, sealing member 20G in the present embodiment includes a first region 20X and a second region 20Y on its surface in contact with sealing plate 120, first region 20X constituting an elastic region that is elastically deformable and that is located at a region including protrusion 130b, second region 20Y having a hardness larger than that of first region 20X, second region 20Y facing first electrolyte solution injection port 10.

For example, as the material of first region 20X, an ethylene-propylene-diene rubber (EPDM) or a material having a hardness of 70 [durometer: type A] is used. As the material of second region 20Y, polyphenylene sulfide (PPS) or a material having a hardness of 120 [Rockwell hardness (R scale)] is used.

Second region 20Y includes: a first cylindrical shape portion 20Y1 embedded (inserted) in first region 20X and including a region (exposed region) facing first electrolyte solution injection port 10; and a second cylindrical shape portion 20Y2 located in first region 20X and having a diameter larger than that of first cylindrical shape portion 20Y1. First cylindrical shape portion 20Y1 is surrounded by second region 20Y. The implementation of support member 30 is the same as that of the first embodiment described above.

Referring to FIG. 14, by applying pressing force to first cylindrical shape portion 20Y1 of sealing member 20G from the first electrolyte solution injection port 10 side using jig 50 so as to compress sealing member 20G, sealing member 20G maintains the open state in which a clearance between sealing member 20G and sealing plate 120 is formed. As a result, the electrolyte solution can be injected into exterior container 110 through first electrolyte solution injection port 10 and second electrolyte solution injection ports 30h (arrows F in the figure). Further, the internal pressure in exterior container 110 can be readily reduced at any timing.

On the other hand, the sealing of first electrolyte solution injection port 10 is maintained only by the elastic force of sealing member 20G with the pressing force being released to release the compression of sealing member 20G by the pressing force (state shown in FIG. 2). Therefore, when accommodating sealing member 20 into support member 30, sealing member 20 is preferably accommodated with sealing member 20 being elastically deformed to some extent.

Thus, sealing member 20G includes first region 20X and second region 20Y having a hardness larger than that of first region 20X, and second region 20Y has a configuration to face first electrolyte solution injection port 10. As a result, the region (second region 20Y) to be deformed from the outside and the region (first region 20X) to provide the sealing are located at different positions.

According to this configuration, the rigidity is secured at the portion (second region 20Y) at which sealing member 20G is deformed from the outside by using the jig, thereby facilitating elastic deformation at the portion (first region 20X) to provide the sealing. As a result, it is possible to readily cause deformation of sealing member 20G from the outside and sufficiently secure the sealing property.

It should be noted that referring to FIG. 15, the configuration in which the region of first cylindrical shape portion 20Y1 of second region 20Y facing first electrolyte solution injection port 10 is exposed (not covered with first region 20X) has been described above. However, even when there is a region at which the first electrolyte solution injection port 10 side of first cylindrical shape portion 20Y1 of second region 20Y is not exposed to first region 20X, there may be a portion at which the region of first cylindrical shape portion 20Y1 facing first electrolyte solution injection port 10 is covered with first region 20X as long as thickness L1 of first region 20X is smaller in size than height H1 of protrusion 130b.

This is due to the following reason: when the thickness of first region 20X (the thickness of the region facing first electrolyte solution injection port 10) located at the region to which the load is applied from the outside is smaller than the amount of compression of first region 20X (height H1 of protrusion 130b) at the time of the sealing, first electrolyte solution injection port 10 can be securely sealed by first region 20X.

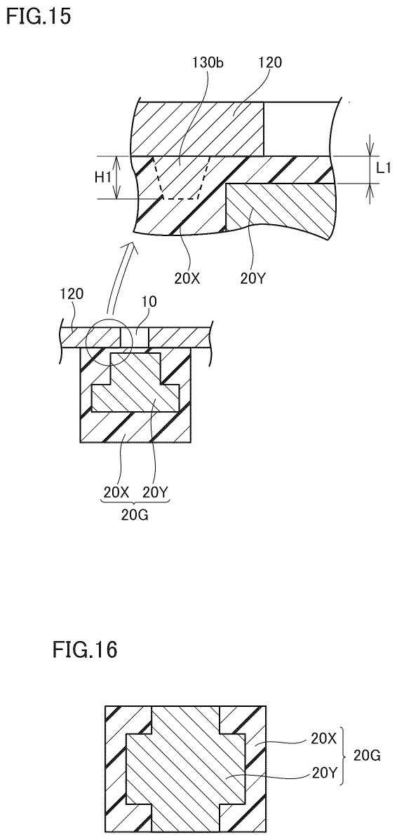

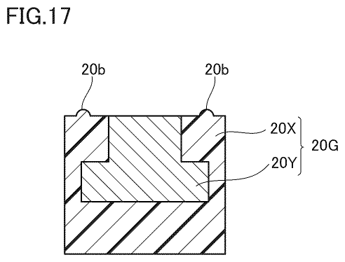

Further, as shown in FIG. 16, second region 20Y may be exposed from first region 20X on the side surface side as long as second region 20Y does not protrude with respect to first region 20X on the surface facing first electrolyte solution injection port 10.

Further, in the above description, the case where protrusion 130b having an annular shape is provided on the sealing plate 120 side has been described, but a protrusion 20b having an annular shape may be provided on the side of first region 20X facing sealing plate 120 as in sealing member 20G shown in FIG. 17.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A secondary battery comprising:
an electrode assembly;
an exterior container provided with an opening; and
a sealing plate that seals the opening with the electrode assembly being accommodated inside the exterior container, wherein
the sealing plate is provided with a first electrolyte solution injection port for injecting an electrolyte solution into the exterior container,
the sealing plate has a sealing member,
the sealing member is supported on a side of the sealing plate inside the exterior container by a support member provided to cover the first electrolyte solution injection port from inside the exterior container,
a protrusion is provided in one of the sealing plate and the sealing member at a region outside the first electrolyte solution injection port in a radial direction, the protrusion having an annular shape and protruding toward the other,
the sealing member includes an elastic region on a surface of the sealing member in contact with the sealing plate at a region including the protrusion, the elastic region being elastically deformable, and
by applying pressing force to the elastic region from a side of the first electrolyte solution injection port so as to compress the elastic region, the sealing member maintains an open state in which a clearance between the sealing member and the sealing plate is formed, and maintains sealing of the first electrolyte solution injection port only by elastic force of the elastic region with the pressing force being released to release compression of the elastic region by the pressing force.

2. The secondary battery according to claim 1, wherein the protrusion is provided on the sealing plate.

3. The secondary battery according to claim 2, wherein the protrusion is composed of the same material as a material of the sealing plate.

4. The secondary battery according to claim 1, wherein the sealing member is constituted of a single elastic material.

5. The secondary battery according to claim 1, wherein
the sealing member includes a first region constituting the elastic region, and a second region having a hardness larger than a hardness of the first region, and
in the second region, a region facing the first electrolyte solution injection port is exposed.

6. The secondary battery according to claim 1, wherein the support member is provided with a second electrolyte solution injection port communicating with an inner portion of the exterior container.

7. The secondary battery according to claim 1, wherein the support member is composed of the same material as a material of the sealing plate.
